(19) United States
(12) Patent Application Publication
(10) Pub. No.: US 2006/0131784 A1
(43) Pub. Date: Jun. 22, 2006

(54) Flexible mold, method of manufacturing same and method of manufacturing fine structures

(76) Inventor: Takaki Sugimoto, Tokyo (JP)

Correspondence Address: 3M INNOVATIVE PROPERTIES COMPANY, PO BOX 33427, ST. PAUL, MN, 55133-3427, US

(21) Appl. No.: 10/537,736

(22) PCT Filed: Dec. 10, 2003
(86) PCT No.: PCT/US03/39141

§ 371 Date: Nov. 21, 2005

(30) Foreign Application Priority Data
Jan. 10, 2003 (JP) 2003-004717

(51) Int. Cl. B29C 59/00; B29C 33/50; B29C 33/40

(52) U.S. Cl. 264/293; 249/127; 264/219

(57) ABSTRACT

A flexible mold (10) having a mold layer (11) that is provided on the surface thereof with a groove pattern (4) of specified shape and size, is constructed such that the mold layer contains a lithium salt of an organic fluorine compound as an antistatic agent.

### FIELD OF THE INVENTION

The present invention relates to a mold and a method of manufacturing a mold, and more particularly to a flexible mold and a method of manufacturing same which is useful for molding a fine structure and which is especially excellent in antistatic performance. The present invention also relates to a method of manufacturing a fine structure using such a flexible mold. In particular, the present invention can be advantageously used for manufacturing ribs of a back panel for a plasma display panel.

### BACKGROUND OF THE INVENTION

As is well known, with the advance and development of television technology, display devices using cathode ray tubes (CRTs) have been produced more and more economically mass-produced. In recent years, however, in place of these display devices using CRTs, thin and light-weight flat display devices have attracted increasing attention.

One of the representative flat panel display devices is a liquid crystal display (LCD) device, which has already been used widely as a compact display device in a notebook-type personal computer, a mobile telephone set, a personal digital assistant (PDA), and other portable electronic information apparatus. On the other hand, a plasma display panel is a typical display device as a thin and large screen size flat panel display, and indeed begins to be used in business, and recently also in home as a wall hanging television screen.

A PDP has the construction as shown schematically in FIG. 1. Although, in the illustrated example, the PDP 50 includes only one discharge cell 56 for display for the sake of simplicity, it generally includes a multiplicity of minute discharge cells for display. More specifically, each discharge cell 56 for display is defined as surrounded by a pair of glass substrates, that is, a front glass substrate 61 and a back glass substrate 51, which are spaced apart from and opposed to each other, and a fine structure of ribs 54 (barrier ribs, sometimes called partition walls or barriers) of a specified shape disposed between these glass substrates. The front glass substrate 61 comprises a transparent display electrode 63 consisting of scanning electrode and sustaining electrode, a transparent dielectric layer 62, and an overlying transparent protective layer 64. The back glass substrate 51 comprises an address electrode 53 and an overlying dielectric layer 52. The display electrodes 63 and the address electrodes 53 are perpendicular to each other, and are respectively arranged spaced apart in a regular pattern. Each discharge cell for display 56 has a fluorescent layer 55 formed on the interior wall thereof, and has a rare gas (for example, Ne—Xe gas) hermetically sealed in the inside so as to enable light emitting display by means of plasma discharge between above-mentioned electrodes.

In general, the ribs 54 consist of a fine structure of ceramics, and together with address electrodes 53, are usually provided on the back glass substrate 51, as shown schematically in FIG. 2, in advance of forming a back panel for PDP. Since the shape and dimensional precision of the ribs significantly affect the performance of PDP, various improvement have been made on the mold used for manufacturing ribs and on the manufacturing method.

For example, a method has been proposed for manufacturing barrier ribs characterized in that metal or glass is used as the mold material and that coating liquid for forming ribs (partition wall) is disposed between the surface of a glass substrate and the mold material, and the mold material is removed after the coating liquid is hardened and thereafter the substrate having the hardened coating liquid transferred thereon is baked (See Japanese Unexamined Patent Publication (Kokai) No. 9-12336). The coating liquid has glass powder of low melting point as a main component.

Also, there has been proposed a method for manufacturing a substrate for PDP, comprising the steps of filling a mixture of ceramic or glass powder with a solvent and a binder consisting of an organic additive into a silicone resin mold having cavities for the partition walls, and joining this mixture integrally to a back panel formed of ceramics or glass (See Japanese Unexamined Patent Publication (Kokai) No. 9-134676).

Further, a method for manufacturing partition walls comprising the steps of forming a partition wall member having a predetermined softness in the shape of a plate of a predetermined thickness on a surface of a substrate, molding the partition wall member under pressure by a press mold provided with a shape corresponding to the partition wall to be formed, releasing the press mold from the partition wall member, and heat-treating the molded partition wall member at a predetermined temperature, has also been proposed (Japanese Unexamined Patent Publication (Kokai) No. 9-283017).

However, there is still a problem of electrification due to static electricity. Since a mold is usually formed of resin material, electrification due to static electricity is likely to occur during its usage, and as a result, the mold tends to attract dust or powder of the molding material, or debris of ribs, so that frequent cleaning is required or the quality of obtained back panel may be adversely affected.

In order to address the problem of static electricity, one approach is a method for antistatic processing of a mold used for manufacturing a substrate for PDP, using an ionic conductive material, preferably lithium perchlorate. (See Japanese Unexamined Patent publication (Kokai) No. 2001-191345). Lithium perchlorate has relatively low ionization energy (high solubility in solvents) compared to other common salts, so that, when blended to organic material such as resins, it increases the electrical conductivity of the material. In accordance with this method, surface electrical resistance of the mold was decreased as a result of the antistatic processing, and adherence of dust or the like could be thereby avoided. In particular, when ionic conductivity was given to the mold by this method, antistatic processing could be performed successfully irrespective of surrounding environment

### SUMMARY OF THE INVENTION

It was found, however, from a recent study that there remains a problem to be solved in this method of antistatic processing using lithium perchlorate. Lithium perchlorate has high oxidative property, and therefore, extreme care needs to be exercised not only in the handling of the salt itself, but also in the handling of the mold material when the salt is blended to the material. Thus, mass production of the molding material or the mold containing lithium perchlorate is very difficult.

In one aspect of the present invention, there is provided a flexible mold comprising a mold layer having a groove pattern of specified shape and size on the surface thereof, wherein said mold layer contains lithium salt of an organic fluorine compound as an antistatic agent.

In another aspect of the present invention, there is provided a method of manufacturing a flexible mold comprising a mold layer having a groove pattern of specified shape and size, said method comprising the steps of:

forming a layer of a photocurable resin material by coating a photocurable resin material containing a lithium salt of an organic fluorine compound as an antistatic agent to a predetermined film thickness on a metal master pattern having on the surface thereof a protrusion pattern in shape and size corresponding to said groove pattern of said mold;

laminating a transparent support consisting of a film of plastic material on said metal master pattern to thereby form a laminate of said metal master pattern, said layer of a photocurable resin material, and said support;

irradiating said laminate with light from the side of the support to harden said layer of photocurable resin material; and

releasing said mold layer formed by the hardening of said photocurable resin material together with said support from said metal master pattern.

In still another aspect of the present invention, there is provided a method of manufacturing a fine structure having a protrusion pattern of specified shape and size on the surface of a substrate, said method comprising the steps of:

providing a flexible mold which has on the surface thereof a groove pattern of shape and size corresponding to said protrusion pattern, said mold layer containing a lithium salt of an organic fluorine compound as an antistatic agent;

placing a curable molding material between said substrate and said mold layer of said mold, and filling said molding material into said groove pattern of the mold;

curing said molding material and forming a fine structure consisting of said substrate and the protrusion pattern integrally connected thereto; and

releasing said fine structure from the mold.

### BRIEF DESCRIPTION OF THE DRAWINGS

FIG. 1 is a cross-sectional view schematically showing an example of conventional PDP to which the present invention can be applied.

FIG. 2 is a perspective view showing a back panel for PDP used in the PDP of FIG. 1.

FIG. 3 is a perspective view showing a flexible mold according to an embodiment of the present invention.

FIG. 4 is a cross-sectional view taken along line IV-IV of the mold in FIG. 3.

FIG. 5a-5c is a cross-sectional view showing a method of manufacturing a flexible mold according to the present invention.

FIG. 6a-6c is a cross-sectional view showing a method of manufacturing a back panel for PDP according to the present invention.

FIG. 7 is a graph plotting the relation between surface resistance and added amount of lithium salt solution relative to the amount of resin material.

FIG. 8 is a graph plotting the relation between electrification voltage and added amount of lithium salt solution relative to the amount of resin material.

### DETAILED DESCRIPTION OF THE PREFERRED EMBODIMENTS

The flexible mold and the method of manufacturing same, and the method for manufacturing a fine structure according to the present invention may be advantageously carried out in various embodiments, respectively. Embodiments of the present invention will be described in detail below with reference to manufacture of ribs for PDP as a typical example of fine structures. It is to be understood that the present invention is by no means restricted to manufacture of ribs for PDP.

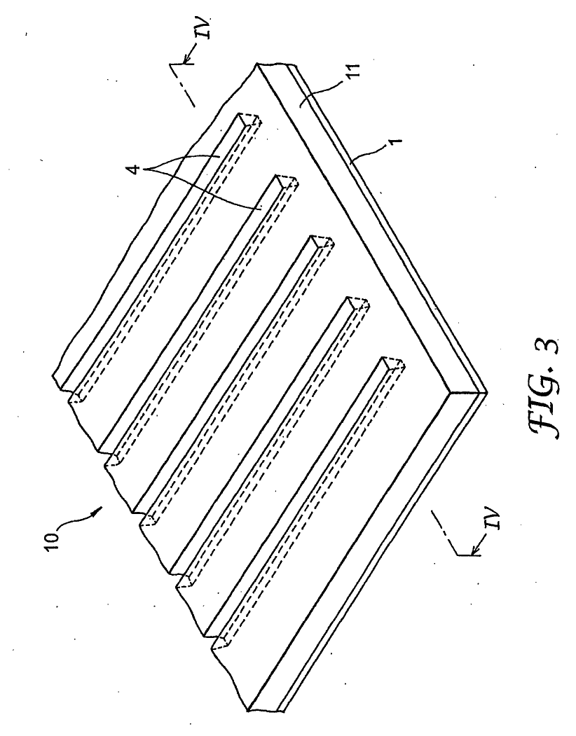

As has already been described with reference to FIG. 2, the ribs 54 for PDP are provided on the back glass substrate 51 to form a back panel for PDP. The spacing C of the ribs 54 (cell pitch) may vary depending upon the size of the screen, and is typically in the range of about 150 to 400 μm. In general, the ribs should satisfy two requirements, that is, “there should be no such defects as inclusion of air bubbles, deformation, and the like” and “the pitch of ribs should have high precision.” With regard to the precision of the pitch, ribs are required to be provided at the specified location with little deviation relative to address electrodes, and indeed the tolerance of the position is within a few tens of μm. If the positional error exceeds a few tens of μm, light emitting condition for visible light is adversely affected, and satisfactory natural light emitting display cannot be expected. Since screen size has become increasingly large nowadays, the problem of the insufficient precision of the rib-pitch can be serious.

When ribs 54 are considered as a whole, the required dimensional accuracy of the total pitch R of ribs 54 (distance between the ribs 54 at both ends; although only 5 ribs are shown in this Figure, usually about 3000 ribs are present) is generally within a few tens ppm, although there may be some difference depending upon the size of the substrate or the shape of the ribs. In general, ribs can be advantageously formed using a flexible mold comprising a support and a mold layer with a groove-pattern supported by the support, and the total pitch of the mold (distance between groove portions at both ends) is also required to satisfy the same dimensional accuracy of a few tens ppm or less as the ribs. In accordance with the present invention, satisfactory dimensional accuracy can be obtained for the pitch of ribs as well as for total pitch.

First, the flexible mold of the present invention useful for manufacturing a back panel for PDP as shown in FIG. 2 will be described with regard to the construction and the method of manufacturing same.

FIG. 3 is a partial perspective view showing schematically a flexible mold according to a preferred embodiment of the present invention. As can be seen from FIG. 3, the flexible mold 10 is designed for the manufacture of a back panel for PDP having a straight rib pattern with a plurality of ribs 54 arranged in parallel to each other as shown in FIG. 2. The flexible mold 10 may be modified in design, although not shown, such that it permits the manufacture of a glass substrate for a PDP back panel having a lattice-shaped rib pattern in which a plurality of ribs are arranged generally in parallel so as to cross each other at a constant spacing, or other type of back panel for PDP.

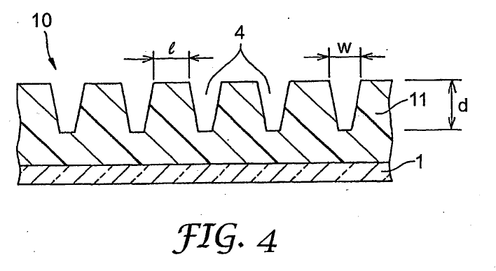

FIG. 4 is a cross-sectional view taken along the line IV-IV of FIG. 3, although the shape and size of the flexible mold of FIG. 3 is not accurately reproduced. As shown in FIG. 4, the flexible mold 10 has a groove pattern of predetermined shape and size on the surface thereof. The groove pattern is a straight rib pattern composed of a plurality of grooves 4 arranged generally in parallel to each other at a constant spacing. The grooves 4 have sides (side walls) preferably inclined as shown in the FIG. 4 so as to permit the ribs to be easily released from the mold. Also, terminating ends of the grooves extending in the longitudinal direction have preferably inclined end surfaces. The shape and size of the grooves 4 may be varied, respectively, in wide range in accordance with the shape and size of the ribs for PDP that are manufactured using the mold. For example, in the case of the mold 10 shown in FIG. 4, as measured on the surface of the mold layer 11, depth d of each groove 4 is typically in the range of about 100 to 400 μm, and preferably in the range of about 150 to 300 μm. Width w of each groove 4 is typically in the range of about 5 to 250 μm, and preferably in the range of about 100 to 200 μm. The length of each groove varies widely depending upon the groove pattern, and cannot be generally defined. Width 1 of the plane portion that lies between two grooves 4 is typically in the range of about 50 to 250 μm, and preferably in the range of about 100 to 200 μm.

As can be easily understood, the flexible mold 10 is formed so as to be provided on the surface with grooves 4 opened on top plane as shown in FIG. 4, so that it can be advantageously used for molding ribs for PDP having a protrusion pattern, for example, a straight protrusion pattern, a lattice-like protrusion pattern, etc. The flexible mold 10 may be formed only of a mold layer 11, or may include additional layers as required, or optional processing may be performed on various layers composing the mold. The flexible mold is preferably composed of a support 1 and a mold layer 11 having a groove 4 thereon. Each of the support 1 and the mold layer 11 is preferably transparent.

The flexible mold of the present invention is characterized in that the mold layer contains lithium salt of an organic fluorine compound as an antistatic agent. The lithium salt of an organic fluorine compound is used, when blended to the constituent material (molding material, preferably resin material) of the mold layer, in an amount effective for sufficient function as an antistatic agent in the blend or obtained mold and for avoiding occurrence of undesired electrification due to static electricity.

The lithium salt of an organic fluorine compound to be blended to the mold layer used in the present invention is not particularly restricted. Lithium salt of an organic fluorine compound suitable in the practice of the present invention is preferably:

(1) a compound having excellent stability to moisture, that is, a compound that does not substantially decomposed in the presence of moisture;

(2) a compound having excellent thermal stability, that is a compound that does not substantially decomposed when heated to an elevated temperature, for example, to about 100° C.; more specifically, a compound that remains stable and does not give rise to thermal decomposition when heated to an elevated temperature of 200° C. or higher, preferably about 300 to 350° C., during the course of molding process using the mold;

(3) a compound having excellent electrical conductivity, that is, a component that exhibits, for example, electrical conductivity of about 5 to 15 mS/cm, preferably about 10 to 12 mS/cm, when measured in PC/DME (propylene carbonate/dimethoxyethane) at the concentration of 1 M (mole).

The lithium salt compound used in the present invention is required to satisfy at least one of these requirements, and satisfies most preferably all of these requirements.

The present inventor has found that suitable lithium salts of organic fluorine compounds to be used in the invention include, but are not limited to, CF₃SO₃Li, (CₙF₂ₙ₊₁SO₂)₂NLi wherein n is an integer of 1 or 2, LiSO₃C₂F₄SO₃Li, CF₃CO₂Li, C₄F₉SO₃Li, (CF₃CO)₂NLi, (CF₃SO₂)₃CLi, and (CF₃SO₂)₂CFLi. These lithium salts may be used alone or in a mixture of two or more of them.

These lithium salts can be used advantageously in the present invention for reasons as described below. Lithium salts such as CF₃SO₃Li, (CF₃SO₂)₂NLi, (C₂F₅SO₂)₂NLi are preferred. Also, it has been confirmed by the applicants that lithium salts such as CF₃SO₃Li, (CF₃SO₂)₂NLi, (C₂F₅SO₂)₂NLi are stable at temperature up to 350° C. In addition, these lithium salts have a low oxidative property so that they can be easily blended to the mold material and there is no difficulty in the management of the obtained blend. Thus, the entire process beginning from the preparation of the mold material, manufacture of the mold, to the storage of the mold, can be implemented far more easily.

Above-mentioned lithium salts of organic fluorine compounds have remarkably excellent antistatic performance. These lithium salts have low ionization energy like lithium perchlorate, and can be advantageously used as an antistatic agent. In general, among a series of lithium salts of organic fluorine compounds, lithium salts having —SO₂ group in the molecule, for example (CₙF₂ₙ₊₁SO₂)₂NLi, have especially high electrical conductivity. In particular, imide salts such as (CₙF₂ₙ₊₁SO₂)₂NLi have two —SO₂ groups in the molecule and especially high electrical conductivity can be expected from these salts.

Above-described lithium salts of organic fluorine compounds may be blended to the mold material as they are, or may be preferably dissolved in a lithium salt-ionizing solvent and then blended to the mold material. Suitable ionizing solvents are polar solvents having a high boiling point of about 200° C. or higher. Examples of polar solvents having a high boiling point suitable for implementing the present invention include, but are not limited to, ethylene carbonate, propylene carbonate, ethylene glycol, lactone, and their derivatives. These ionizing solvents may be used alone or in combination of two or more of them. These ionizing solvent may be used in varied amount for dissolving lithium salts, and is typically used preferably in an amount in the range of about 0.01 to 10% by weight, more preferably in the range of about 0.1 to 1.0% by weight, relative to total weight of the mold material.

Effective blended amount of lithium salt in the mold layer may be varied depending upon various factors such as the kind of lithium salt and the kind of the mold material, and typically, it is preferably in the range of about 0.01 to 5% by weight, and more preferably in the range of about 0.05 to 1% by weight, relative to total weight of the mold material. If the blended amount of such lithium salt is less than 0.01% by weight, desired antistatic effect cannot be obtained. If, on the contrary, the blended amount is more than 5% by weight, the antistatic effect is saturated.

The mold layer is preferably formed of hardened piece of a photocurable resin material. The mold layer that can be used advantageously for implementing the present invention is a thin film that is formed by hardening a resin material by application of heat, light, or other energy after the film is formed by coating a curable resin material. The curable resin material is, therefore, preferably a heat-curable resin material or photocurable resin material. Especially, a photocurable resin material can be advantageously used, since it does not require a large and long heating furnace for forming the mold layer, and hardening can be carried out in relatively shore period. The photocurable resin material is preferably a photocurable monomer or oligomer, more preferably an acrylic monomer or oligomer, and most preferably a (meth)acrylate, that is, an acrylate or methacrylate, monomer or oligomer.

More specifically, acrylic monomers suitable for forming the mold layer include, but are not limited to, urethane acrylate, polyester acrylate, polyether acrylate, acryl amide, acryl nitrile, acrylic acid, acrylic ester. Acrylic oligomers suitable for forming the mold layer include, but are not limited to, urethane acrylate oligomer, epoxy acrylate oligomer. In particular, urethane acrylate and its oligomer can provide a flexible and strong hardened piece after curing, and has a very high curing speed among acrylates in general, so that it can contribute to improvement of the productivity of the mold. In addition, when these acrylate monomers or oligomers are used, the obtained mold layer becomes optically transparent. Thus, the flexible mold having such a mold layer permits a photocurable molding material to be used in the manufacture of PDP ribs or other fine structures. These acrylic monomers or oligomers may be used alone or in an arbitrary combination of two or more of them. Although features of acrylate monomers or oligomers are described above, similar features can be obtained for methacrylate monomers or oligomers.

The curable resin material may contain an optional additives. For example, when the curable resin material is a photocurable resin material, suitable additives may include a photoinitiator. For example, as a photoinitiator, the most suitable compound should be selected in accordance with the type of the curable resin material, and examples may include 2-hydroxy-2-methyl-1-phenyl-propane-1-on, bis(2,4,6-trimethylbenzoyl)-phenyl phosphin oxide. These photoinitiators may be used alone or in combination of two or more of them. The photoinitiator may be used in widely variable amount depending upon the type of the curable resin material, and is typically used in an amount in the range of about 0.1 to 10% by weight, and preferably in the range of about 0.5 to 2% by weight, relative to the total amount of the curable resin material.

In addition to the lithium salt of an organic fluorine compound used in the present invention, other antistatic agent such as lithium perchlorate, lithium nitrate, etc., may be used in additional small amount, as long as the operative effect of the present invention is not adversely affected, or rather, the operative effect of the present invention can be thereby improved.

Other additives that can be used include, for example, amine surfactants, ionic surfactants, etc.

The mold layer may be used in varied thickness depending upon such factors as shape and size of ribs. Typically, the thickness of the mold layer is in the range of about 5 to 1000 μm, preferably in the range of about 100 to 500 μm. If the mold layer is too thin, ribs of specified height cannot be formed. The thickness of the mold layer may be suitably modified depending upon the presence or absence of a support.

The mold layer is preferably carried by a support. The support that carries the mold layer may be composed of an arbitrary material, and since flexibility suitable for handling needs to be given to the mold, it is preferably composed of a support material having suitable hardness or softness.

With regard to hardness of the support material, it is preferable to select, as the support material, a material that is much harder than the mold material forming the mold layer involved in forming the groove (preferably, a photocurable material such as photocurable resins), preferably a plastic material having a high glass transition temperature. Since, in general, hardening shrinkage of a photocurable resins is about a few %, if a soft plastic film is used for the support, the hardening shrinkage of the former may give rise to dimensional change in the support itself and dimensional accuracy of the groove pitch cannot be controlled within a few tens of ppm. If, on the contrary, the plastic film is hard, dimensional accuracy of the support itself can be maintained even after the hardening shrinkage of the photocurable resin, and the dimensional accuracy of the groove pitch can be maintained in high precision. Also, when the plastic film is hard, the pitch variation during formation of the ribs can be kept small. This is advantageous both in moldability and in dimensional accuracy. Examples of hard plastic film suitable for implementing the present invention include those listed below.

If the plastic film is hard, since dimensional accuracy of the groove pitch of the mold depends only upon the dimensional change of the plastic film, in order to provide a mold having desired dimensional accuracy of the groove pitch, it is sufficient to perform post-processing such that dimension of the plastic film is as intended and shows no change in the mold after the manufacture.

Hardness of the support material may be expressed, for example, as rigidity to tension, that is, as tensile strength. The tensile strength of the support material is typically at least about 5 kg/mm², and preferably at least about 10 kg/mm². If the tensile strength of the support material is less than 5 kg/mm², workability in the handling is degraded when the obtained mold is released from the metal master pattern 5 or when the PDP rib is released from the mold, and this may lead to breaking or rupture.

Preferable support for implementing the present invention is a film of plastic material having good workability in handling as well as good hardness. Examples of plastic material suitable for the support include, but are not limited to, polyethylene terephthalate (PET), polyethylene naphthalate (PEN), stretched polypropylene, polycarbonate, triacetate, etc. Among them, PET film is particularly useful for the support, and for example, polyester film such as Tetron™ film may be advantageously used as the support. These plastic films may be used alone as a single layer film or two or more of them may be used in combination as a composite film or a laminated film.

Above-described plastic film or other support may be used in varied thickness depending upon the construction of the mold or the PDP, and the thickness is typically in the range of about 50 to 500 μm, and preferably in the range of about 100 to 300 μm. If thickness of the support is outside of above-mentioned range, workability in handling may be degraded. The thicker the support, the more advantageous it is in strength.

The present invention also relates to a method of manufacturing the flexible mold as described above. The method of manufacturing the flexible mold according to the present invention comprises, in particular, the steps of:

forming a layer of a photocurable resin material by coating a photocurable resin material containing a lithium salt of an organic fluorine compound as an antistatic agent to a predetermined film thickness on a metal master pattern having on the surface thereof a protrusion pattern in shape and size corresponding to the groove pattern of the mold;

laminating a transparent support consisting of a film of plastic material on said metal master pattern to thereby form a laminate of said metal master pattern, said layer of a photocurable resin material, and said support;

irradiating said laminate with light from the side of the support to harden said layer of photocurable resin material; and

releasing said mold layer formed by the hardening of said photocurable resin material together with said support from said metal master pattern.

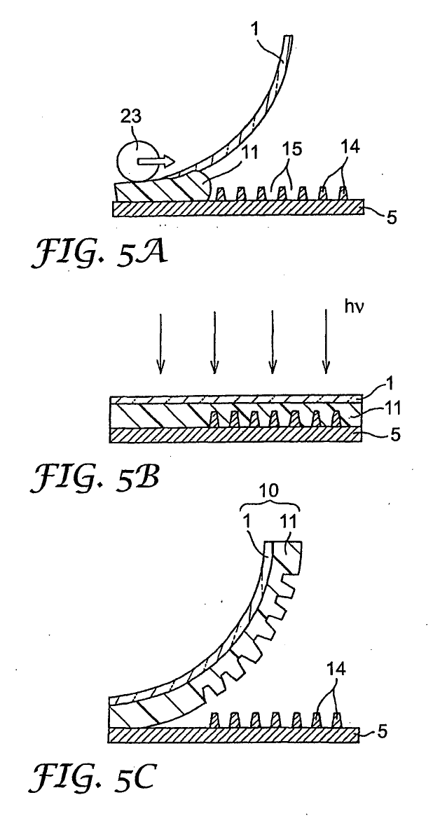

The method of manufacturing the flexible mold according to the present invention may be implemented in various modifications within the scope of the present invention. For example, a flexible mold for manufacturing a substrate (back panel) for PDP as shown in FIG. 2, which has the construction as shown schematically in FIGS. 3 and 4, may be manufactured advantageously by following steps as shown in order in FIG. 5.

First, as shown in FIG. 5(A), a metal master pattern 5 having shape and size corresponding to the substrate for PDP to be manufactured, a support 1 consisting of a transparent plastic film (hereinafter referred to as support film), and a laminate roll 23 are provided. The metal master pattern 5 has partition walls 14 on the surface thereof which are of the same pattern and shape as the ribs on the back panel for PDP. Thus, a space (recess) 15 defined by adjoining partition walls 14 is to be used as a discharge display cell in PDP. Taper may be provided in the upper end portion of the partition wall 14 so as to prevent inclusion of bubbles. Inclined surface may be provided at the terminating end portion of respective partition walls to facilitate removal of the obtained mold from the metal master pattern. In any event, by providing a metal master pattern having identical shape to the final form of ribs, need of processing of end portion of ribs after the manufacture can be eliminated, and occurrence of defects due to debris produced in the processing of end portion can be avoided. In the present manufacturing method, all the material for forming ribs is hardened so that very little residue of molding material is left on the metal master pattern, and therefore, reuse of the metal master pattern becomes quite easy. The laminate roll 23 consists of a rubber roll and serves to press the support film 1 to the metal master pattern 5. Other known or customary laminating means may be used in place of the laminate roll. The support film 1 consists of a polyester film or other transparent plastic film as described above.

Then, using known or customary coating means such as a knife coater or a bar coater (not shown), photocurable mold material 11 is coated to the end surface of the metal master pattern 5 in a specified amount. When a flexible and elastic material is used as the support film 1, even if shrinkage of the photocurable mold material 11 takes place, close contact with the support film 1 prevents dimensional change of 10 ppm or greater as long as the support film itself does not deform.

Prior to laminating process, aging treatment is preferably performed under the manufacturing environment in order to avoid dimensional change of the support film due to humidity. Unless the aging treatment is performed, unacceptable dimensional variation (for example, variation on the order of 300 ppm) may arise in the obtained mold.

Next, the laminate roll is slid on the metal master pattern 5 in the direction of an arrow. As a result of this laminating process, the mold material 11 is evenly distributed evenly in specified thickness, and gaps between the partition walls 14 are filled with the mold material 11.

After the laminating process has been completed, with the support film 1 laminated on the metal master pattern 5 as shown in FIG. 5(B), the mold material is irradiated with light (hv) as shown by arrows. If the support film 1 does not include light scattering elements such as air bubbles, and is formed uniformly of the transparent material, the irradiated light can reach the mold material evenly with little attenuation. As a result of irradiation, the mold material is hardened efficiently and forms a homogeneous mold layer 11 having the support film 1 adhered thereto. Thus, a flexible mold is obtained with the support film 1 and the mold layer 11 integrally joined in one unit. Since ultraviolet light of wavelength in the range of 350 to 450 nm, for example, can be used, this process is advantageous in that it is not necessary to use a light source generating large amount of heat, for example, a high pressure mercury lamp such as a fusion lamp. Since thermal deformation of the support film or the mold layer during the photocuring can be thus avoided, leading to another advantage that the pitch can be controlled in high precision.

Next, as shown in FIG. 5(C), the flexible mold 10 is released without impairing its integrity from the metal master pattern 5. If necessary, the flexible mold 10 may be placed in a thermohygrostat and subjected to a conditioning process following a predetermined schedule. With this conditioning process, undesired dimensional change of the obtained mold can be suppressed, and a mold having proper size can be obtained.

The flexible mold of the present invention can be manufactured relatively simply, irrespective of the size and dimensions, as long as suitable well known and conventional laminating means and coating means are employed. Thus, in accordance with the present invention, in contrast to the conventional manufacturing process using vacuum equipment such as vacuum press molding machine etc., a large-size flexible mold can be manufactured simply and easily with no limitation.

Moreover, the flexible mold of the present invention is useful in the manufacture of various fine structures. For example, the flexible mold of the invention is useful for molding of ribs for PDP with straight rib pattern or lattice rib pattern. Thus, by using the flexible mold, a large screen size PDP with rib structure that does not permit leakage of UV light from discharge cells for display can be easily manufactured simply by employing a laminate roll in place of vacuum equipment and/or complicated process.

The present invention is therefore also directed to a manufacturing process for manufacturing fine structures using the flexible mold of the invention. The method of manufacturing a fine structure according to the present invention comprises, in particular, the steps of:

providing a flexible mold that has on the surface thereof a groove pattern of shape and size corresponding to the protrusion pattern of the fine structure, said mold layer containing a lithium salt of an organic fluorine compound as an antistatic agent;

placing a curable molding material between said substrate and said mold layer of said mold, and filling said molding material into said groove pattern of the mold;

curing said molding material and forming a fine structure consisting of said substrate and the protrusion pattern integrally connected thereto; and

releasing said fine structure from said mold.

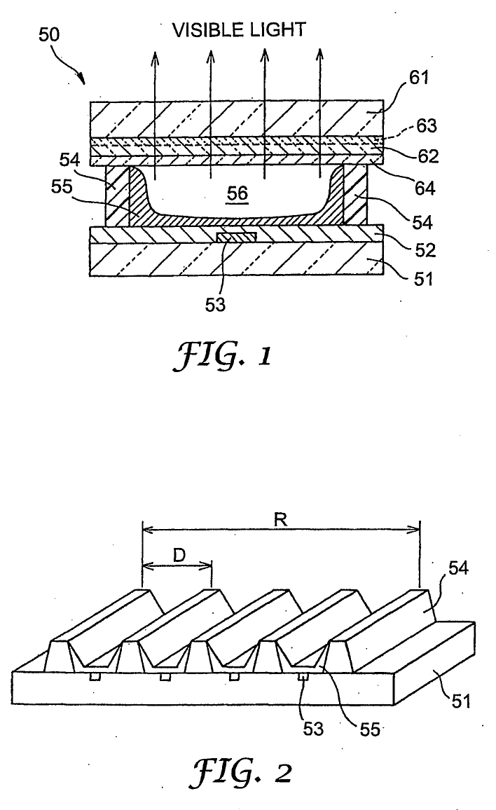

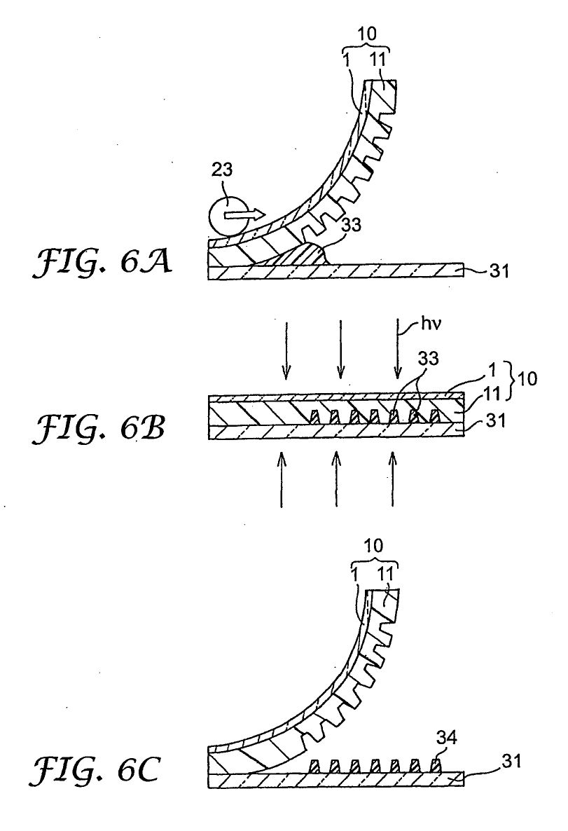

As can be understood from the foregoing, the fine structure may have various structures, and is typically exemplified by a substrate (back panel) for PDPs which is provided with ribs on a glass plate. The manufacturing process of a substrate for PDP as shown in FIG. 2 will be described below with reference to FIG. 6. Manufacturing equipment as shown in FIGS. 1 to 3 of Japanese Unexamined Patent Publication (Kokai) No. 2001-191345, for example, can be advantageously used in implementing this manufacturing process.

First, a glass plate is provided with electrodes arranged in parallel to each other at a constant spacing, and is set on a surface plate. Then, as shown in FIG. 6(A), the flexible mold 10 of the present invention is placed at specified position on the glass plate 31, and the glass plate 31 and the mold 10 are suitably aligned with each other. The flexible mold 10 is preferably provided in advance with an alignment mark such as a cross mark formed in an area other than the rib-forming area. Since the mold 10 is optically transparent, the alignment with the electrodes on the glass plate 31 can be carried out easily. More specifically, the alignment may be performed visually, or by using a sensor such as a CCD camera, such that the grooves of the mold 10 are set in parallel to the electrodes on the glass plate 31. If necessary, temperature and humidity may be adjusted to bring the grooves into coincidence with the spacing between adjoining electrodes on the glass plate 31. This adjustment is required because the mold 10 and the glass plate 31 expands or contracts to different extent in accordance with change of temperature and humidity. Therefore, after the alignment of the glass plate 31 with the mold 10 has been completed, temperature and humidity need to be controlled so as to remain constant. This control method is especially effective in the manufacture of a large area substrate for PDP.

Then, a laminate roll 23 is placed on an end portion of the mold 10. The laminate roll 23 is preferably a rubber roll. Here, the one end portion of the mold 10 is preferably fixed on the glass plate 31, so that displacement of the mold 10 with respect to the glass plate 31 may be avoided after the alignment has been completed.

Next, the other free end portion of the mold 10 is raised by a holder (not shown) above the laminate roll 23 to expose the glass plate 31. At this time, the mold 10 should not be subjected to tension. This is for preventing the mold 10 from being wrinkled and for maintaining the alignment of the mold 10 with the glass plate 31. Other means may be employed as long as the alignment can be maintained. In the present manufacturing process, since the mold 10 has elasticity, the mold 10 can be restored at the time of laminating process, accurately to the initial position of the alignment after it has been raised as shown in the Figure.

Then, specified amount of rib precursor 33 required to form ribs is supplied onto the glass plate 31. The rib precursor can be supplied using, for example, a hopper with nozzle for paste.

As used herein, the term “rib precursor” means any molding material that can be formed into the rib molding as the intended end product, and there is no special limitation as long as the rib molding can be formed. The rib precursor may be thermo-setting or photocurable. In particular, a photocurable rib precursor can be used very effectively in combination with the above-described transparent flexible mold. As described above, the flexible mold rarely includes air bubbles or defects such as deformations, and can suppress uneven scattering of light. Therefore, the molding material is hardened uniformly to form ribs of constant and good quality.

An example of composition suitable for the rib precursor is a composition basically including:

(1) a ceramic component for giving the shape of the ribs, such as aluminum oxide;

(2) a glass component for filling the gap between the ceramic component and adding density to the ribs, such as lead glass or phosphate glass; and

(3) a binder for containing, holding and binding ceramic component with each other, and its curing agent or polymerization initiator. Hardening of the binder component is preferably achieved not by heating or warming, but by irradiation with light, since thermal deformation of the glass plate no longer needs to be considered in this case. If necessary, in order to lower the temperature for removing the binder component, an oxidation catalyst consisting of oxides, salts or complexes of chromium (Cr), manganese (Mn), iron (Fe), cobalt (Co), nickel (Ni), copper (Cu), zinc (Zn), indium (In) or tin (Sn), ruthenium (Ru), rhodium (Rh), palladium (Pd), silver (Ag), iridium (Ir), platinum (Pt), gold (Au) or cerium (Ce) may be added to the composition.

In the practice of the illustrated manufacturing process, the rib precursor 33 is not supplied uniformly to the entire glass plate 31. As shown in FIG. 6(A), the rib precursor 33 has only to be supplied to the portion of the glass plate 31 near the laminate roll 23, since, in the step described later, the laminate roll 23 is moved on the mold 10 so as to spread the rib precursor 33 uniformly on the entire glass plate 31. In this case, it is desirable that the rib precursor 33 has viscosity of typically about 20,000 cps or less, preferably about 5,000 cps or less. If the viscosity of the rib precursor is higher than about 20,000 cps, it is difficult to spread the rib precursor sufficiently with the laminate roll, and as a result, air may be entrained into the groove portion of the mold, and may become a cause of defects of the ribs. In fact, if the viscosity of the rib precursor is about 20,000 cps or less, the laminate roll needs to be moved from one end of the glass plate to the other end only once for spreading the rib precursor uniformly between the glass plate and the mold and filling all groove portions uniformly without giving rise to inclusion of air bubbles. Method of supplying the rib precursor is not restricted to the above-described method. For example, the rib precursor may be coated to the entire surface of the glass plate, although this is not shown. In this case, the rib precursor for coating has the same viscosity as described above. In particular, when ribs in the shape of a lattice pattern are to be formed, the viscosity of the rib precursor is typically about 20,000 cps or less, preferably 5,000 cps or less.

Next, a rotary motor (not shown) is driven to move the laminate roll 23 on the mold 10 as shown by the arrow in FIG. 6(A). While the laminate roll 23 is thus moved on the mold 10, pressure is applied to the mold 10 successively from one end portion to the other end portion by the weight of the laminate roll 23 itself so that the rib precursor 33 is spread between the glass plate 31 and the mold 10 and is filled into the grooves of the mold 10. Thus, the rib precursor successively replaces air in the grooves and is filled into it. The rib precursor may be spread in the thickness in the range of a few μm to a few tens μm by suitably controlling the viscosity of the rib precursor, or the diameter, weight or moving speed of the laminate roll.

With the illustrated manufacturing process, the grooves of the mold also acts channels for air so that, even if air is captured in the groove, the air can be efficiently discharged through this channel out of the mold to surroundings when pressure is applied as described above. Consequently, the present manufacturing process can prevent inclusion of remaining air bubbles even if the grooves are filled with rib precursor under atmospheric pressure. In other words, reduced pressure needs not be applied in filling the rib precursor. It is to be understood that reduced pressure may be utilized to further facilitate removal of air bubbles.

Then, the rib precursor is hardened. If the rib precursor 33 which are spread on the glass plate 31 is photocurable, the laminate consisting of the glass plate 31 and the mold 10 is placed in a irradiation apparatus (not shown), and the rib precursor 33 is irradiated with light such as ultraviolet ray (UV) via the glass plate 31 and the mold 10, as shown in FIG. 6(B). After hardening, a molding of the rib precursor, that is, the rib per se is obtained.

Finally, with the obtained rib 34 adhered to the glass plate 31, the glass plate 31 and the mold 10 are removed from the irradiation apparatus, and the mold 10 is separated and removed, as shown in FIG. 6(C). Since the mold 10 of the present invention is excellent in ease of handling, if a material of low adhesion is used as coating layer of the mold, the mold 10 can be easily separated and removed with small force without damaging the rib 34 adhered to the glass plate 31. It should be appreciated that no large scale apparatus is required for the separation and removal of the mold.

The present invention will now be described more specifically with reference to the following examples. It should be easily understood by those skilled in the art that the present invention is by no means restricted to these examples.

### EXAMPLES

### Example 1

Fabrication of the Flexible Mold:

For the manufacture of back panel for PDP, a rectangular metal master pattern having ribs (partition walls) in a straight pattern was prepared. More specifically, the metal master pattern had ribs with the cross section along the longitudinal direction in the shape of isosceles trapezoid arranged at a constant pitch. The space (recess) defined by adjoining ribs corresponds to a discharge cell for display for PDP. Each of the ribs was 135 μm in height, 60 μm in top width, and 120 μm in bottom width. Pitch (distance between the centers of adjoining ribs) was 300 μm, and number of ribs was 3000. Total pitch (distance between the centers of ribs at both ends) was 900.221 mm.

In order to be used in forming the mold layer of the mold, a photocurable resin was prepared by mixing aliphatic urethane acrylate oligomer (manufactured by Daicel-UCB, Co.), phenoxyethyl acrylate, and 2-hydroxy-2-methyl-1-phenyl-propane-1-one (photoinitiator: Trade name “Darocure 1173”; manufactured by Chiba Speciality chemicals, Co.) in weight ratio of 100:25:1.25. Then, a propylene carbonate solution of (CF₃SO₂)₂NLi was added to this mixture as an antistatic agent. The amount of the added antistatic agent was 0.5% by weight relative to the amount of UV-curable resin. Concentration of the lithium salt was 20% by weight. The UV-curable resin for forming mold layer was thus obtained.

In order to be used as the support for the mold, PET film of 1300 mm in width and 100 μm in thickness (Trade name, “HPE”; manufactured by Teijin Co.) was provided.

Then, the above-described UV-curable resin was coated in the shape of a line to the upstream end of the prepared metal master pattern. Then, above-described PET film was laminated on the surface of the metal master pattern so as to cover it. When a laminate roll was used carefully to press the PET film, the UV-curable resin was filled into the recesses of the metal master pattern.

In this state, the UV-curable resin was irradiated via the PET film using a fluorescent lamp (manufactured by Mitsubishi-Osram Co.) with light having wavelength of 300 to 400 nm for 30 seconds. The UV-curable resin was hardened and the mold layer was thus obtained. Then the PET film together with the mold layer was released from the metal master pattern, and thus a flexible mold having a multiplicity of grooves of shape and size corresponding to the ribs on the metal master pattern was obtained. Thickness of the mold layer was about 300 μm.

Fabrication of a Back Panel for PDP:

After the flexible mold was fabricated as described above, the mold was arranged in alignment to a glass substrate for PDP. The mold was placed with the groove-pattern facing the glass substrate. Then, photosensitive ceramic paste was filled between the mold and the glass substrate. The ceramic paste used had following composition.

Photocurable Oligomer:

dimethacrylate of bisphenol-A-diglycidyl ether (manufactured by Kyoeisya Chemical Co.) 21.0 g

Photocurable Monomer:

triethyleneglycol dimethacrylate (manufactured by Wako Pure Chemicals Industries, Co.). 9.0 g

Diluent:

1,3-butanediol (manufactured by Wako Pure Chemical Industries, Co.) 30.0 g

Photoinitiator:

bis(2,4,6-trimethylbenzoyl)-phenyl phosphine oxide (Trade name “Irgacure 819”; manufactured by Chiba Speciality Chemicals, Co.)

0.3 g

Surfactant:

phosphate propoxyalkyl polyol 3.0 g

Inorganic Particle:

mixed powder of lead glass frit and ceramic particles (manufactured by Asahi Glass, Co.) −180.0 g

After the ceramic paste has been filled, the mold was laminated so as to cover the surface of the glass substrate. When laminate roll was used carefully to press the mold against the substrate, the ceramic paste was completely filled into the grooves of the mold.

In this state, a fluorescent lamp (manufactured by Philips Co.) was used to irradiate the ceramic paste with light having wavelength of 400 to 450 nm for 30 seconds from both sides via the mold and the glass substrate. The ceramic paste was hardened to form the ribs. Then, the glass substrate together with the ribs formed thereon was separated from the mold, and a back panel for PDP consisting of the glass substrate with ribs formed thereon was obtained as intended.

### Example 2

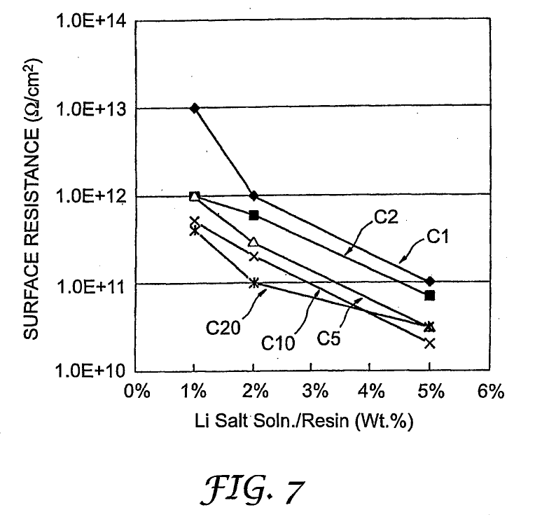

The procedure described in Example 1 was repeated to fabricate a flexible mold. In the present Example, in order to evaluate the effect of concentration of lithium salt solution and added amount of the solution relative to the amount of resin upon surface resistance of the mold, lithium salt solutions of different concentration, as shown in FIG. 7, that is:

C1 . . . 1% by weight propylene carbonate solution

C2 . . . 2% by weight propylene carbonate solution

C5 . . . 5% by weight propylene carbonate solution

C10 . . . 10% by weight propylene carbonate solution

C20 . . . 20% by weight propylene carbonate solution

were used, and blended amount of the lithium salt solution relative to the amount of resin was also varied in the range of 1 to 5% by weight.

After each of the lithium salt solutions was blended to resin in different blending amount to prepare UV-curable resin, each of the UV-curable resins was coated to PET film of 100 μm in thickness and irradiated with UV-light to fabricate the mold with a mold layer of 300 μm in thickness.

With obtained molds, surface resistance (Ω/cm²) of the mold layer was measured at the temperature of 22° C. and relative humidity (RH) of 55%, and measurement result as plotted in FIG. 7 was obtained. For measurement of surface resistance, a commercially available measurement apparatus (Model 1272A; manufactured by Monroe Electronics Inc.) was used. As can be seen from the graph shown in FIG. 7, surface resistance of the mold can be lowered by increasing the concentration of added lithium salt solution and blended amount of the solution relative to the total amount of resin. In general, when blended amount of lithium salt solution relative to resin is in the range of about 0.01 to 5% by weight, satisfactorily lowered surface resistance can be obtained.

### Example 3

The procedure described in Example 1 above was repeated to fabricate a flexible mold. In the present Example, in order to evaluate the effect of blended amount of lithium salt solution relative to total amount of resin upon electrification voltage of the mold, lithium salt solution in the form of 20% by weight propylene carbonate solution (C20) was used and the blended amount of the lithium salt solution relative to total amount of resin was varied in the range of 0.0 to 2.0% by weight.

After UV-curable resin was prepared by blending the lithium salt solution in different blended amount, each UV-curable resin was coated to a PET film of 100 μm in thickness and was irradiated with UV light to form the mold with a mold layer of 300 μm in thickness.

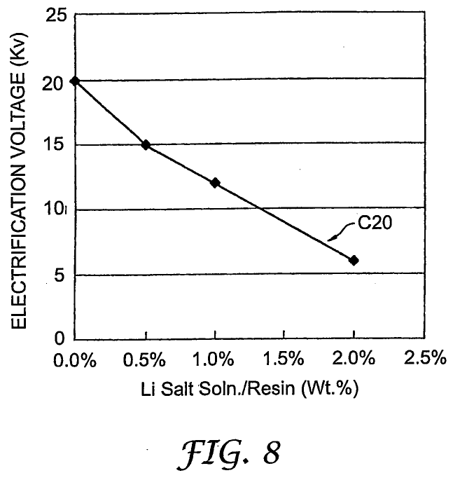

Next, each mold was cut to form a test specimen of length 850 mm×width 350 mm. On this test specimen of mold layer, a PET film (Trade name “HPE”: manufactured by Teijin Co.) of same size as the test specimen and 100 μm in thickness was adhered. The test specimen was fixed at one side thereof to a transverse member and was suspended vertically like a Noren. With the test specimen suspended, the adhered PET film was peeled off at the speed of about 300 mm/s, and the electrification voltage (Kv) immediately after peeling was measured at temperature of 22° C. and relative humidity (RH) of 55%. Measurement result as plotted in FIG. 8 was thus obtained. For the measurement of electrification voltage, a commercially available electrification measuring apparatus (Model FMX-002; manufactured by SIMCO Co.) was used. As can be seen from the graph shown in FIG. 8, the electrification voltage of the mold can be lowered by adding the lithium salt solution, and by increasing the blended amount of the lithium salt solution relative to the total amount of resin.

1. A flexible mold comprising a mold layer having on the surface thereof a groove-pattern of specified shape and size, wherein said mold layer comprises a lithium salt of an organic fluorine compound as an antistatic agent.

2. A flexible mold according to claim 1, wherein said lithium salt of an organic fluorine compound is at least one lithium salt selected from the group consisting of CF₃SO₃Li, (CₙF₂ₙ₊₁SO₂)₂NLi wherein n is an integer of 1 or 2, LiSO₃C₂F₄SO₃Li, CF₃CO₂Li, C₄F₉SO₃Li, (CF₃CO)₂NLi, (CF₃SO₂)₃CLi, (CF₃SO₂)₂CFLi.

3. A flexible mold according to claim 1, wherein said lithium salt of an organic fluorine compound is blended in an amount of 0.01 to 5% by weight relative to the amount of the resin material forming said mold layer.

4. A flexible mold according to claim 1, wherein said mold layer is transparent.

5. A flexible mold according to claim 1, wherein said mold layer consists of a hardened product of a curable resin material.

6. A flexible mold according to claim 5, wherein said curable resin material is selected from the group comprising a photocurable monomer, a photocurable oligomer, and mixtures thereof.

7. A flexible mold according to claim 6, wherein said curable resin is selected from the group comprising an acrylic monomer, an acrylic oligomer, and mixtures thereof.

8. A flexible mold according to claim 7, wherein said curable resin is selected from the group comprising a (meth)acrylate monomer, a(meth)acrylate oligomer, and mixtures thereof.

9. A flexible mold according to claim 8, wherein said (meth)acrylate monomer and/or oligomer are/is selected from the group consisting of urethane (meth)acrylate, polyester (meth)acrylate, polyether (meth)acrylate.

10. A flexible mold according to claim 1, wherein said mold layer has a thickness of 5 to 1000 μm.

11. A flexible mold according to claim 1, wherein the mold further comprises a support carrying said mold layer.

12. A flexible mold according to claim 1, wherein the mold is used for molding ribs of a back panel for a plasma display panel.

13. A flexible mold according to claim, wherein said lithium salt of an organic fluorine compound is not decomposed thermally at temperature below 200° C. during the course of molding process using said mold.

14. A flexible mold according to claim 1, wherein said groove pattern of the mold layer is a straight pattern composed of a plurality of grooves arranged at a constant spacing generally in parallel to each other.

15. A flexible mold according to claim 1, wherein said groove pattern of the mold layer is a lattice-shaped pattern composed of a plurality of grooves arranged so as to cross at a constant spacing generally in parallel to each other.

16. A flexible mold according to claim 1, wherein, in said mold layer, said groove pattern is defined by plane portions and grooves, and wherein said groove has depth of 100 to 400 μm and width of 50 to 250 μm as measured at the surface of said mold layer.

17. A flexible mold according to claim 11, wherein said support is a film of plastic material.

18. A flexible mold according to claim 17, wherein said plastic material is at least one plastic material selected from the group consisting of polyethylene terephthalate, polyethylene naphthalate, stretched polyethylene, polycarbonate, and triacetate.

19. A flexible mold according to claim 11, wherein said support has a thickness of 50 to 500 μm.

20. A method of manufacturing a flexible mold which has a mold layer provided on the surface thereof with a groove pattern having specified shape and size, said method comprising the steps of:
forming a layer of a photocurable resin material by coating a photocurable resin material containing a lithium salt of an organic fluorine compound as an antistatic agent to a predetermined film thickness on a metal master pattern having on the surface thereof a protrusion pattern in shape and size corresponding to said groove pattern of said mold;
laminating a transparent support consisting of a film of plastic material on said metal master pattern to thereby form a laminate of said metal master pattern, said layer of a photocurable resin material, and said support;
irradiating said laminate with light from the side of the support to harden said layer of photocurable resin material; and
releasing said mold layer formed by the hardening of said photocurable resin material together with said support from said metal master pattern.

21. A method of manufacturing a fine structure having a protrusion pattern of specified shape and size on the surface of a substrate, said method comprising the steps of: providing a flexible mold having a mold layer which has on the surface thereof a groove pattern of shape and size corresponding to said protrusion pattern, said mold layer containing a lithium salt of an organic fluorine compound as an antistatic agent;
placing a curable molding material between said substrate and said mold layer of said mold, and filling said molding material into said groove pattern of the mold;
hardening said molding material and forming a fine structure consisting of said substrate and the protrusion pattern integrally connected thereto in one unit; and
removing said fine structure from the mold.

22. A method of manufacturing a fine structure according to claim 21, wherein said fine structure is a back panel for a plasma display panel.
